(19) United States
(12) Patent Application Publication
(10) Pub. No.: US 2016/0319867 A1
(43) Pub. Date: Nov. 3, 2016

(54) PLAIN BEARING MATERIAL AND A PLAIN BEARING COMPOSITE MATERIAL, COMPRISING ZINC SULPHIDE AND BARIUM SULPHATE

(71) Applicant: FEDERAL-MOGUL WIESBADEN GMBH, WIESBADEN (DE)

(72) Inventors: ACHIM ADAM, NAUHEIM (DE); NORBERT FLEISCHHACKER, LORSCH (DE)

(21) Appl. No.: 15/107,691

(22) PCT Filed: Dec. 22, 2014
(86) PCT No.: PCT/EP2014/079008

§ 371 Date: Jun. 23, 2016

(30) Foreign Application Priority Data
Dec. 27, 2013 (DE) 10 2013 227 187.5

(51) Int. Cl. F16C 33/20; C08K 3/22; C08L 77/06; C08L 81/06; C08L 81/04; C08K 3/30; C08L 71/00

(52) U.S. Cl. CPC F16C 33/201; F16C 33/205; C08K 3/30; C08K 3/22; C08L 71/00; C08L 81/06; C08L 81/04; C08L 77/06; F16C 2208/30; F16C 2208/82; C08K 2003/3036; C08K 2003/3045; C08K 2003/2272

(57) ABSTRACT

A plain bearing material is provided which comprises between 50 and 85% vol. % of a fluoropolymer as a base material, the remainder being fillers comprising zinc sulfide and barium sulfate and optionally up to 40 vol. %, based on the total filler content, of additional fillers, wherein the volume ratio of zinc sulfide to barium sulfate is between 0.1 and 15.7, preferably between 0.8 and 4.88 and particularly preferably between 1.5 and 3.44. The plain bearing material can be embedded in a mechanically stabilized framework of a composite material. In particular, in a layered composite material having a metal backing, on which said composite material is arranged.

The present invention relates to a plain bearing material based on plastic and a plain bearing composite material comprising the corresponding plain bearing material.

Attempts are made in many cases to produce the bearing so that it is free of maintenance. To be able to achieve freedom from maintenance, the bearing must have good dry running properties, and also be functional without the addition of lubricants, wherefore the materials used must be able to take high tribological loads.

It is known from DE 195 24 968 to use fluoropolymers as base material, which contain fillers, with which the dry running property of the bearing can be improved. The dry running property is usually characterized by means of the wear rate, for example in μm/min.

Plain bearing materials, which comprise PTFE (polytetrafluoroethylene) and as filler MoS₂ (molybdenum disulfide), PTFE and lead or PTFE, CaF₂ (calcium difluoride) and ZnS (zinc sulfide), have been known and used for a long time. In particular, bearing materials based on PTFE containing the fillers MoS₂ or hexagonal boron nitride (h-BN) have a high tribological load capacity.

MoS₂ is a mineral product, which has a high processing requirement for production of uniform quality. Lead is no longer usable as a filler due to its toxic properties, and CaF₂ and ZnS alone lead to a wear rate which is not adequate for all relevant applications. Hexagonal BN is currently a very expensive material, so that use thereof as a filler is disadvantageous for economic reasons.

Bearing materials with sliding layers containing PTFE and zinc sulfide have been known for some time and now are counted among standard materials. In EP 1 390 629 B1, such a material is described based on PTFE having 10-25 vol.-% ZnS, to which carbon fibers and PPSO₂ are added. In DE 10 2006 048 311 A1, a composition is described consisting of a plastic matrix having at least most 20% PTFE and additions of 5-15% barium sulfate or zinc sulfide.

Also, the filler combination of zinc sulfide and barium sulfate, optionally with further fillers, is under consideration. EP 1 716 342 B1 proposes, for example a material with increased pore volumes and plastic matrix made of 50 vol.-% PVDF or 60 vol.-% PA, PESU or PPS, in which over 5 vol.-% PTFE and at least 5 vol. %, preferably 8 to 12 vol. % zinc sulfide and/or barium sulfate are contained. Examples thus contain either only zinc sulfide or barium sulfate. EP 1 526 296 A2 describes a material based on PEEK-, PPS- or PA, comprising a hardening component and carbon fibers, but without PTFE, having a ZnS and/or BaSO₄ proportion of 5 to 15 wt. %, wherein only compositions with ZnS are concretely named. DE 36 01 569 A1 discloses the addition of fine-particle ZnS and BaSO₄ as an additive for polymers in plastic-compound composite bearings, wherein zinc sulfide may be contained in a proportion of 5 to 40 vol.-%, with respect to the matrix material, and up to 5 vol. % BaSO₄, with respect to the zinc sulfide particles. The exemplary embodiments are selected, so that either only zinc sulfide or only barium sulfate or zinc sulfide with a minor amount of 0.5 vol. % barium sulfate can be used.

However, the improvements of the wear rate achieved in this way are still not sufficient for many applications, so that the object of the present invention is to provide a plain bearing material having fluoropolymers as base material, which has a lower wear rate than known plain bearing materials.

This object is achieved with a plain bearing material of the aforementioned type by means of a combination of 50 to 85 vol. % of a fluoropolymer as base material containing fillers, which comprise zinc sulfide and barium sulfate and optionally up to 40 vol. % of further fillers, based on the total filler content, wherein the volume ratio of zinc sulfide to barium sulfate is between 0.1 and 15.7, preferably between 0.1 and 10.0, more preferably between 0.8 and 4.88 and particularly preferably between 1.5 and 3.44.

It has been shown that the wear rate with the constitution according to the present invention, when compared to materials which either contain only zinc sulfide or only barium sulfate or zinc sulfide with a low percentage of barium sulfate, may be significantly improved in a surprising way. The wear rate can be reduced compared to the known plain bearing materials based on fluoropolymers comprising zinc sulfide fillers over the entire claimed range of the volume ratio of zinc sulfide to barium sulfate by a factor of 1.5 and at a ratio of 0.1 to 10 even by a factor of more than 2. In the once more narrower range up to a ratio of 1.5 to 3.44, the wear rate starting therefrom improves once again by up to a factor of 2, and altogether even by a factor of 5. Compared to the known plain bearing materials based on fluoropolymers comprising barium sulfate-filler, the wear rate at a ratio of 0.1 to 10 can be reduced by more than a factor of 1.6, and in the narrowest range by over a factor of 3.

Preferably the zinc sulfide and the barium sulfate is present in powder form with an average particle size of 5 μm or less and in particular 1 μm or less.

In this way, on the one hand a further reduction of the wear rate can be achieved, on the other hand, the dispersibility during manufacturing of the plain bearing material can be improved, which simplifies the manufacturing process, thereby reducing the costs.

The zinc sulfide and barium sulfate content is particularly preferred in the form of lithopone.

Lithopone is a mixture produced by common precipitation of zinc sulfide and barium sulfate, which is obtainable with compositions of 10 to 90 up to 60 to 40, thus a volume ratio of zinc sulfide to barium sulfate of 0.11 to 1.5.

Preferably the additional fillers are present in a proportion of 2 to 20 vol.-% of the total filler content.

The additional fillers are selected according to technical application and comprise thermosetting plastics or high temperature plastics.

The thermosetting plastics or high temperature thermoplastics enable a further reduction of the wear rate to be reached without affecting the surface of the bearing. They increase in particular the bearing capacity of the plastic layer itself and make possible longer operating periods without exposure of the sintered structure. As high temperature thermoplastics for this purpose, polyimides, polyamide-imides, PEEK (polyetheretherketones), PPSO₂ (polyphenylene sulfone), PPS (polyphenylene sulfide), full- or partial aromatic polyamides or polyesters or a mixture thereof have proved to be especially suitable.

The properties can thereby be further influenced, when the additional fillers are solid lubricants. Graphite, metal sulfide with layer structure or hexagonal boron nitride have proven to be particularly effective. The solid lubricant can improve the wear rate and the load capacity, in particular in the operating state, in which the sintered state is exposed and therefore becomes the sliding partner.

Furthermore, the wear rate can be reduced in particular under media lubrication, when the additional filler pigments comprise coke or iron oxide, in particular.

When the additional fillers comprise fibers, for example graphite short fibers or aramid fibers, the mechanical load capacity, in particular against shear forces, can be improved.

It has also proved to be advantageous when the additional fillers comprise hard materials, for example boron carbide or silicon nitride. Due to the grinding or polishing effect of such hard materials, the wear rates in particular of the plain bearing materials of the invention can be further improved, when the counter-rotating surface is abrasive.

A particularly far-reaching reduction of the wear rate, also when no media lubrication is present, results surprisingly with use of iron (III) oxide. It is advantageous, if the additional fillers, based on the total composition of the plain bearing material comprise 0.5 to 8.5 vol. % iron (III) oxide, preferably 1 to 5 vol. % iron (III) oxide and particularly preferably 1 to 3 vol. % iron (III) oxide. The average particle size of the iron (III) oxide is 5 μm or less. This results in particularly homogeneous layer- and surface properties.

All of the aforementioned fillers may be combined within the scope of the stated maximum quantity highest amount of 40 vol. %, preferably of up to 20 vol. %.

The fluoropolymer is preferably PTFE (polytetrafluoroethylene) or a mixture or copolymers of PTFE with PFA (perfluoralkoxyl alkane), MFA (tetrafluoroethylene perfluoromethylvinylether), FEP (perfluoroethylene propylene), ETFE (ethylene tetrafluorethylene), PCTFE (polychlorotrifluoroethylene) or PVDF (polyvinylidene fluoride).

According to a further aspect of the invention, the object is also achieved by a plain bearing composite material having a mechanically stabilized framework, in which the above-described plain bearing material is embedded.

The mechanically stabilized framework functions to increase the bearing capacity of the plain bearing material, which certainly has the said excellent tribological properties, but by itself has little loading capacity.

According to an advantageous embodiment of the composite material, the framework is formed by a plastic matrix, the volume percentage thereof, with respect to the volume of the total composite being between 60 and 95% and preferably between 65 and 80%.

In a preferred development of the composite of the invention, the plastic matrix comprises thermosetting plastics or thermoplastics such as PPS (polyphenylene sulfide), PPA (polyphthalamide), PVDF (polyvinylidene fluoride), PSU (polysulfone), PESU (polyethersulfone), PEI (polyetherimide), PEEK (polyetheretherketone), PAI (polyamide-imide) or PI (polyimide) or a mixture thereof.

Another advantageous embodiment of the composite provides that the framework is formed by a metal mesh or by an expanded metal.

The framework is particularly preferably formed by a sinter matrix, in which the plain bearing material is impregnated.

The impregnation takes place in a known manner, in that the open-pore sinter matrix as a rule is coated under pressure with an aqueous suspension of the plain bearing material, whereby the paste fills in the pores of the matrix and forms a closed top layer depending on the quantity. The material thus produced is subsequently subjected to a heat treatment at 350 to 400° C., wherein the plain bearing material is sintered.

Particularly preferably, the sintered matrix has a pore volume of 15 to 50%, wherein the pores are completely filled in with the plain bearing material.

It is also preferred, when the sinter matrix is coated with a top layer made of the plain bearing material, which has a thickness of up to 150 μm, preferably of 5 to 40 μm.

The sinter matrix is preferably a metallic matrix and consists particularly preferably of bronze comprising 5 to 15 wt. % tin.

In the case of composites based on PTFE-sinter bronze, the performance capacity is improved to the extent that under lubricant-free conditions pV-values in the average load- and speed range of up to 4 MPa m/s can be reached, if a maximum wear rate of 5 μm/km is set as a limit. By pV-value is meant in general the value of the maximal allowable product of load and sliding speed, up to which the fixed rate of wear, in this case 5 μm/km, is still not exceeded. At the same time, these materials have favorable coefficients of friction in dry operation.

According to a further aspect of the invention, the object is also achieved by a bearing-layer composite material having a metal backing, upon which a composite material of the type described above is disposed.

The so-called supporting metal imparts increased strength to the layered composite material.

Both the metal mesh or the expanded metal as well as the plastic matrix or the sinter bronze can be arranged for consolidation of the bearing on such a metal backing.

However, the invention is basically also implementable in the design of solid plastic sliding elements, or various double- and multi-layer composites, for example comprising solid bearing metal coatings as the substrate.

The invention will be described in detail by means of preferred embodiments with reference to the accompanying drawings. In the drawings

FIG. 1 shows a schematic diagram of a first embodiment of the plain bearing layered composite material of the invention,

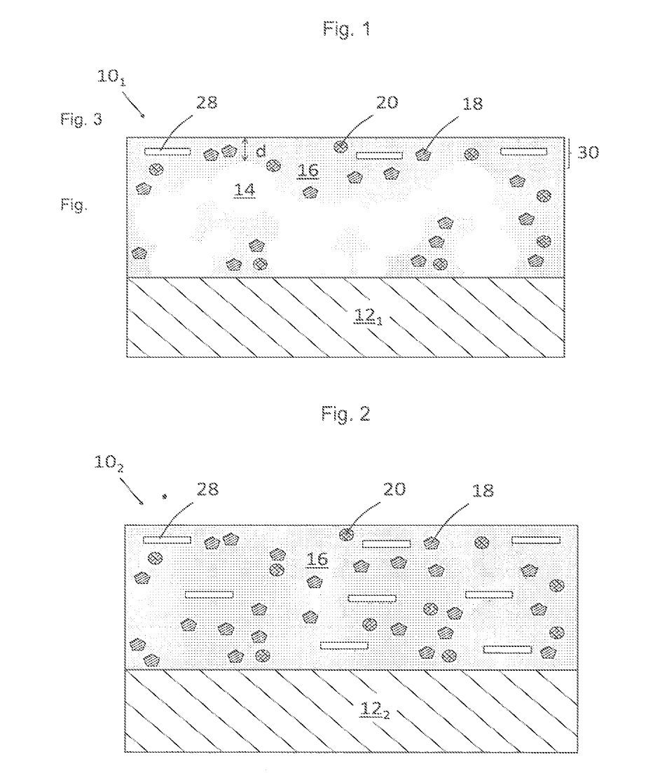

FIG. 2 shows a schematic diagram of a second embodiment of the plain bearing layered composite material of the invention

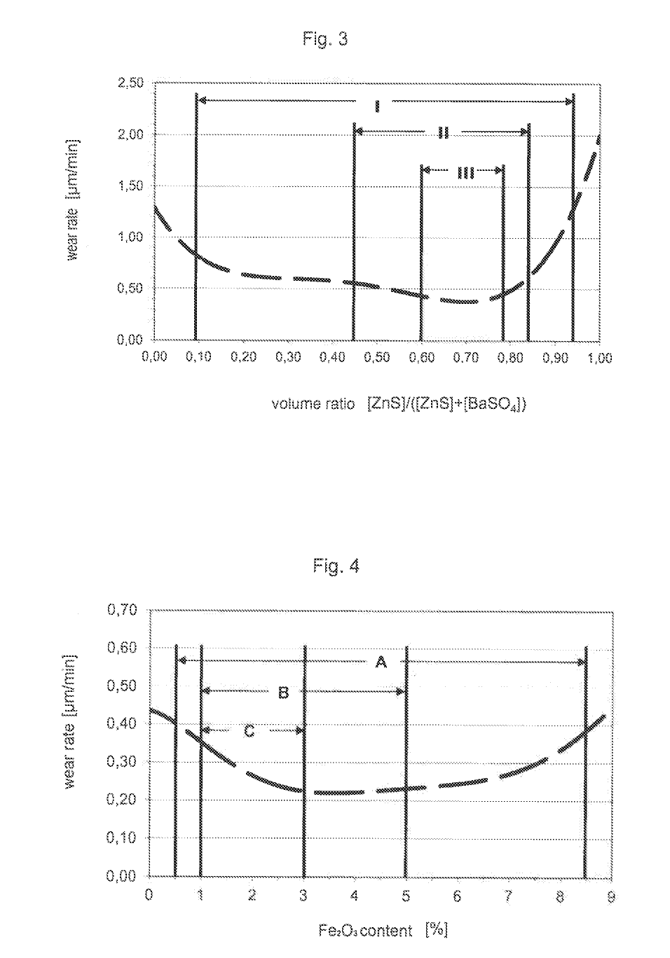

FIG. 3 shows a diagram, which shows the dependency of the wear rate on the ratio between zinc sulfide and barium sulfate, and

FIG. 4 shows a diagram, which shows the dependency of the wear rate on the content of iron (III) oxide as additional filler.

FIG. 1 shows a first embodiment of a plain bearing layered composite material 10₁ according to the invention, which comprises a metal backing 12₁, a framework mechanically stabilized on the metal backing 12₁ in the form of a porous sinter layer 14, for example made of bronze, and a plain bearing material 16, which is adherently bonded to the porous layer 14. The sinter matrix is coated with a continuous top layer 30 made of the plain bearing material. In other words, the layer height defined by the sinter matrix 14 is less than the height of the plain bearing material 16. The thickness d of the top layer 30 is up to 150 μm and lies preferably in the range of 5 to 40 μm. The top layer will be worn out after a certain running time, so that subsequently the sliding layer lying thereunder with the load-bearing sinter matrix 14 is used with the counter-rotating member. The plain bearing layered composite material 16 comprises a volume content of 50 to 85% of a fluoropolymer and zinc sulfide 18 and barium sulfate 20 as fillers. The plain bearing layered composite material 16 also contains an additional filler 28.

In FIG. 2 a second embodiment of a bearing-layered-composite material 10₂ is depicted, which comprises a metal backing 12₂ and a sliding layer bonded adherently directly to the metal backing 12₂, wherein the sliding layer is formed by the plain bearing material 16. The plain bearing material is otherwise constructed the same as in the first embodiment.

FIG. 3 shows the wear rate of plain bearing materials based on PTFE as a function of the ratio of the added fillers zinc sulfate to barium sulfate. The ZnS-volume content is shown normalized to the sum of the volumes of both fillers.

In order to test the wear resistance, the addition of ZnS and BaSO₄ was varied in each case from 0% to 100% of the total amount of filler. Other fillers were not present. The cumulative volume fraction of zinc sulfide and barium sulfate in the total volume of the plain bearing material is constant at 30%. Samples of these plain bearing materials were processed into trilayer plain bearing layered composites, which consisted of a 1.25 mm thick steel back, a 0.2 mm to 0.23 mm thick sinter-bronze and a 0.02 mm to 0.05 mm thick top layer there above. The wear rates of these samples were respectively measured and compared by means of a pin-roller tribometer with specimens of 78 mm² at 0.52 m/s and a load of 17.5 Mpa.

In region I of the diagram of FIG. 3 the volume ratio zinc sulfide to barium sulfate is between 0.1 and 15.7 and the ZnS content normalized to the total volume of both fillers is between 0.09 and about 0.94. Outside of this region, the wear rate on both sides has in each case the most significant increase, so that the wear rate in this region is consistently less than 1.3 μm/min and in direct comparison with the compositions having in each case pure zinc sulfide or barium sulfate, already drops approximately 33% lower.

In region II, which depicts a section of region I and includes a volume ratio of zinc sulfide to barium sulfate between 0.8 and 4.88, which corresponds to a normalized ZnS fraction of about 0.44 to 0.83, the wear rate of the plain bearing material is 0.6 μm/min or less and thus is only approximately half of the wear rate of a composition comprising pure zinc sulfide.

While the wear rate with a varying ratio between 0.2 und 0.4 scarcely changes, if the zinc sulfide content increases further, a repeated decrease of the wear rate can be detected. In region III, in which the volume ratio of zinc sulfide to barium sulfate is between 1.5 and 3.44, the normalized ZnS volume fraction is between 0.6 and 0.77, and thus also therein lies the minimum of the wear rate of the plain bearing material according to the invention. In the entire region III, the wear rate is under 0.5 μm/min and has a minimum at about 0.4 μm/min, which represents a considerable reduction by a factor of 3 to 5 compared to the known plain bearings.

In FIG. 4 the dependency of the wear rate on the content of the iron (III) oxide as a further filler 28 is shown, wherein the volume fraction of the fluoropolymer, in this case PTFE, is 70% in the plain bearing material and the ratio of zinc sulfide to barium sulfate is 3.0. This corresponds to a zinc sulfide fraction of 0.75 normalized to the total volume of zinc sulfide and barium sulfate at the upper limit of region III in the graphic of FIG. 3. Consequently, without addition of iron (III) oxide a wear rate of about 0.43 μm/min is to be expected, which is also confirmed by the starting point of the curve in the diagram of FIG. 4.

As FIG. 4 further shows, the wear rate can be further reduced by addition of iron (III) oxide (Fe₂O₃). The volume fraction of the Fe₂O₃ was increased in the experiments up to 9.0 vol. %, based on the total composition of the plain bearing material, wherein a significant lowering of the wear rate was detectable in a region A of 0.5 to 8.5 vol. %.

The region B of 1 to 5 vol. % Fe₂O₃ is preferred, where the wear rate for the tested samples drops to a minimum value of 0.22 μm/min and thereby is reduced by a factor of up to 6 or 9 compared to the compositions comprising zinc sulfide or barium sulfate. However, it must be taken into account that the Fe₂O₃ has an abrasive effect on the mating surface. This is certainly desired to a small extent during the wearing-in, but not permanently. Therefore, region B is not approximately centered around the minimum at about 3.5 vol. % Fe₂O₃, but is already cut upward at 5 vol. %.

For the same reason, region C of 1 to 3 vol.-% Fe₂O₃ includes not even the minimum, but ends with a Fe₂O₃ content, at which the wear rate is only about 0.23 μm/min.

The results of the wear rate tests for selected compositions of the invention are summarized in Table 1 and compared with comparable materials. The compositions of the plain bearing material according to the invention comprise as before PTFE, zinc sulfide and BaSO₄ as well as additional fillers in the regions given in the Table. The structure of the plain bearing layered composite material is identical to that described before. This also applies for the comparative composition. Finally, the test conditions for the determination of the wear rate are identical to those described above. Furthermore, the friction was determined.

TABLE 1

| | | | | Lithopone | | | | |
|---|---|---|---|---|---|---|---|---|
| | PTFE | BaSO₄ | ZnS | (32% ZnS) | Fe₂O₃ | PEEK | PPS | PPTA |
| Examples | Vol % | Vol % | Vol % | Vol % | Vol % | Vol % | Vol % | Vol % |
| Comp A | 70 | 30 | | | | | | |
| Comp B | 70 | | 30 | | | | | |
| Comp C | 70 | 28 | 2 | | | | | |
| Comp D | 70 | 1 | 29 | | | | | |
| Comp E | 55 | 2 | 43 | | | | | |
| Comp F | 85 | 14 | 1 | | | | | |
| 1 | 70 | 9 | 21 | | | | | |
| 2 | 55 | 13.5 | 31.5 | | | | | |
| 3 | 85 | 7.5 | 7.5 | | | | | |
| 4 | 65 | | | 35 | | | | |
| 5 | 70 | 8.7 | 20.3 | | 1 | | | |
| 6 | 70 | 8.4 | 19.6 | | 2 | | | |
| 7 | 70 | 19.6 | 8.4 | | 2 | | | |
| 8 | 70 | 8.1 | 18.9 | | 3 | | | |
| 9 | 65 | | | 32 | 3 | | | |
| 10 | 75 | 10 | 10 | | | 5 | | |
| 11 | 75 | 12.25 | 5.25 | | | | 7.5 | |
| 12 | 75 | 10 | 10 | | | | | 5 |
| 13 | 75 | 15.75 | 6.75 | | | | | |
| 14 | 70 | 11.25 | 11.25 | | 2.5 | 5 | | |
| 15 | 70 | 14 | 6 | | 2.5 | | 7.5 | |
| 16 | 70 | | | 25 | | | | 5 |
| 17 | 65 | | | 27.5 | 2.5 | | | |
| 18 | 80 | 3. | 9.1 | | 2 | | | |
| 19 | 70 | 11.25 | 11.25 | | | | | |
| 20 | 75 | | | 20 | | | | |
| 21 | 65 | 20.3 | 8.7 | | 3.5 | | | |
| 22 | 75 | 13.65 | 5.85 | | 2 | | | |
| 23 | 70 | | | 25 | 2 | | | |
| 24 | 70 | 6.6 | 15.4 | | | | | |
| 25 | 75 | | | 15 | | | | |

| | | | | | Aramid- | | Wear- | |
|---|---|---|---|---|---|---|---|---|
| | PPSO2 | MoS₂ | h-BN | C-fiber | fiber | Si₃N₄ | rate | |
| Examples | Vol % | Vol % | Vol % | Vol % | Vol % | Vol % | μm/min | Friction |
| Comp A | | | | | | | 1.43 | 0.260 |
| Comp B | | | | | | | 1.91 | 0.230 |
| Comp C | | | | | | | 0.91 | 0.255 |
| Comp D | | | | | | | 1.44 | 0.230 |
| Comp E | | | | | | | 1.68 | 0.220 |
| Comp F | | | | | | | 2.01 | 0.240 |
| 1 | | | | | | | 0.39 | 0.225 |
| 2 | | | | | | | 0.78 | 0.220 |
| 3 | | | | | | | 0.92 | 0.230 |
| 4 | | | | | | | 0.59 | 0.240 |
| 5 | | | | | | | 0.33 | 0.230 |
| 6 | | | | | | | 0.25 | 0.230 |
| 7 | | | | | | | 0.35 | 0.250 |
| 8 | | | | | | | 0.25 | 0.235 |
| 9 | | | | | | | 0.32 | 0.230 |
| 10 | | | | | | | 0.37 | 0.240 |
| 11 | | | | | | | 0.53 | 0.240 |
| 12 | | | | | | | 0.38 | 0.245 |
| 13 | 2.5 | | | | | | 0.65 | 0.235 |
| 14 | | | | | | | 0.24 | 0.240 |
| 15 | | | | | | | 0.27 | 0.250 |
| 16 | | | | | | | 0.53 | 0.230 |
| 17 | 5 | | | | | | 0.28 | 0.230 |
| 18 | | 5 | | | | | 0.49 | 0.215 |
| 19 | | | 7.5 | | | | 0.4 | 0.210 |
| 20 | | | 5 | | | | 0.71 | 0.205 |
| 21 | | | | 2.5 | | | 0.23 | 0.265 |
| 22 | | | | | 3.5 | | 0.25 | 0.240 |
| 23 | | | | | 3 | | 0.27 | 0.230 |
| 24 | | 4 | | | | 4 | 0.47 | 0.245 |
| 25 | | | 5 | | | 5 | 0.55 | 0.240 |

First, it should be noted, that the comparative values (“Comp A” to “Comp F”) and the materials according to the invention (“1” to “25”) show no significant differences in the coefficients of friction. In particular examples, such as number 18, 19 and 20, a reduction of the coefficient of friction can indeed be found. However, this is attributable to the addition of solid lubricants.

In contrast, examples 1 to 3 already confirm from the table that the wear rate in the claimed range of the ratio of zinc sulfide to barium sulfate significantly falls back to the wear rate achievable with the comparative examples. This is recognizably true also for compositions having totally higher filler proportions, as the comparison of examples 2 and 3 with comparative example E demonstrates. This is also not changed by the addition of further fillers (except iron (III) oxide), as the comparison of examples 1 to 3 with examples 10 to 13 shows.

However, a reduction of the wear rate is detectable, when the filler Fe₂O₃ is added, as examples 5 to 8 without Fe₂O₃ show in comparison to examples 1 to 3 with Fe₂O₃ or even also compared with all examples with further fillers sometimes in combination with and sometimes without Fe₂O₃.

Furthermore, the effectiveness of lithopone with 32 vol. % ZnS and 68 vol. % BaSO₄ was tested. Corresponding results of the pin-roller test bench are given in Table 1 as examples 4, 9, 16, 17, 20, 23, 25. It is clear, that these particular homogeneous mixtures are also usable to bring about the effects according to the invention.

Examples 10-17 illustrate the influence of additives of high temperature thermoplastics as additional fillers, examples 18-20 show the influence of solid lubricants and examples 21-23 the influence of fibers. In examples 24 and 25, Silicon nitride (Si₃N₄) was added as hard material, and also a solid lubricant was used additionally, in order to counteract negative effects on the friction coefficient and an abrasion of the counter running surface.

As already explained, the mixture comprising fluorothermoplastics, BaSO₄, ZnS and optionally Fe₂O₃ and further fillers may also be embedded in a matrix made of thermoplastic materials, the volume fraction of which, based on the volume of the total composite material, is between 60 and 95% and preferably between 65 and 80%. These can also then be processed into sliding elements both as solid plastic or as layered composite material on a metal substrate, for example steel or steel having a porous sintered layer made of bronze.

Exemplary compositions for this purpose volume % are:

### 70% PEEK, 21% PTFE, 2.7% ZnS, 6.3% BaSO₄

### 90% PEEK, 8.5% PTFE, 0.75% ZnS, 0.75% BaSO₄

80% PEEK, 10.6% PTFE, 2.7% ZnS, 6.4% BaSO₄, 0.4% Fe₂O₃

### 65% PESU, 19.2% PTFE, 4.6% ZnS, 11.2% BaSO₄

### 80% PESU, 14% PTFE, 1.8% ZnS, 4.2% BaSO₄

70% PESU, 25.2% PTFE, 2.25% ZnS, 2.25% BaSO₄, 0.3% Fe₂O₃

### 70% PPS, 16.5% PTFE, 3.9% ZnS, 9.6% BaSO₄

### 85% PPS, 10.5% PTFE, 1.35% ZnS, 3.15% BaSO₄

60% PPS, 26.8% PTFE, 3.6% ZnS, 8.4% BaSO₄, 1.2% Fe₂O₃

### 80% PPA, 17% PTFE, 1.5% ZnS, 1.5% BaSO₄

### 60% PPA, 22% PTFE, 5.2% ZnS, 12.8% BaSO₄

70% PPA, 20.1% PTFE, 2.7% ZnS, 6.3% BaSO₄, 0.9% Fe₂O₃

Hereinafter, the production of a plain bearing material will be explained by way of example. The production can take place with use of a PTFE-dispersion, in which zinc sulfide and barium sulfate and optionally further filler are mixed, so that they are entrained in homogeneous distribution in the subsequently induced coagulation. Thereby, a pasty mass results that possesses the properties required for the subsequent coating process, and the leaked liquid must be removed prior to the coating process.

For example, 12 L water, 25 g sodium lauryl sulfate, 6.3 kg zinc sulfide, and 3.0 kg barium sulfate were vigorously stirred for 20 min and 36 kg of a 30% PTFE-dispersion was then added. After 2 min further stirring, 100 g of a 20% aluminum nitrate solution was added and after coagulation 1 L toluene was also added and stirring was continued for 3 min.

### LIST OF REFERENCE NUMBERS

10₁, 10₂ plain bearing layered composite material
12 metal backing
14 porous layer
16 plain bearing material
18 zinc sulfide (ZnS)
20 barium sulfate (BaSO₄)
28 additional filler
30 sliding layer

1. A plain bearing material comprising 50 to 85 vol. % of a fluoropolymer as base material and containing fillers, which comprise zinc sulfide and barium sulfate and optionally up to 40 vol. %, with respect to the total filler content, of additional fillers, wherein the volume ratio of zinc sulfide to barium sulfate is between 0.1 and 15.7.

2. The plain bearing material (16) according to claim 1, wherein the zinc sulfide and the barium sulfate are present in powder form having an average particle size of 5 μm or less.

3. The plain bearing material according to claim 1, wherein the zinc sulfide and barium sulfate content is present in the form of lithopone.

4. The plain bearing material according to claim 1, wherein the additional fillers are present in a proportion of 2 to 20 vol.-% of the total filler content.

5. The plain bearing material according to claim 1 wherein the additional fillers are selected from a group comprising thermosetting plastics, high temperature thermoplastics such as polyimides, polyamide-imides, PEEK, PPSO2, PPS, full- or partial aromatic polyamides or polyesters or a mixture thereof; solid lubricants such as graphite, metal sulfides or hexagonal boron nitride; pigments such as coke or iron oxide; fibrous materials such as graphite short fibers or aramid fibers; and hard materials such as boron carbide or silicon nitride.

6. The plain bearing material according to claim 1, wherein the additional fillers, based on the total composition of the plain bearing material, comprises 0.5 to 8.5 vol iron (III) oxide.

7. The plain bearing material according to claim 1, wherein the fluoropolymer is PTFE or a mixture of PTFE with PFA, MFA, FEP, ETFE, PCTFE or PVDF.

8. A plain bearing composite material wherein a mechanically stabilizing framework, in which the plain bearing material according to claim 1 is embedded.

9. The plain bearing composite material according to claim 8, wherein the framework is formed by a plastic matrix, the volume fraction of which, based on the volume of the total composite material, is between 60 and 95%.

10. The plain bearing composite material according to claim 9, wherein the plastic matrix comprises one or more thermosetting plastics or thermoplastics selected from the group consisting of PPS, PPA, PVDF, PSU, PESU, PEI, PEEK, PAI or PI.

11. The plain bearing composite material according to claim 8, wherein the framework is formed by a metal mesh or an expanded metal.

12. The plain bearing composite material according to claim 8, wherein the framework in which the plain bearing material is impregnated is formed by a sinter matrix.

13. The plain bearing composite material according to claim 12, wherein the sinter matrix has a pore volume of 15 to 50%, wherein the pores are filled in with the plain bearing material.

14. The plain bearing composite material according to claim 13, wherein the sinter matrix is coated with a top layer made of the plain bearing material, which has a thickness of up to 150 μm.

15. The plain bearing composite material according to claim 12, wherein the sinter matrix consists of a bronze containing 5 to 15 wt. % tin.

16. The plain bearing composite material comprising a metal backing, on which a plain bearing composite material according to claim 12 is disposed.

17. The plain bearing material according to claim 1, wherein said volume ratio is between 0.8 and 4.88.

18. The plain bearing material according to claim 1, wherein said volume ratio is between 1.5 and 3.44.

19. The plain bearing material according to claim 2, wherein said average particle size is 1 μm or less.

20. The plain bearing material of claim 6, wherein said additional fillers comprises 1 to 5 vol % iron (III) oxide.

21. The plain bearing material of claim 6, wherein said additional fillers comprises 1 to 3 vol % iron (III) oxide.

22. The plain bearing composite material of claim 8, wherein said plastic matrix is between 65 to 80%.

23. The plain bearing composite material of claim 14, wherein said top layer has a thickness of between 5 to 40 μm.
